(19) United States
(12) Patent Application Publication
(10) Pub. No.: US 2024/0312445 A1
(43) Pub. Date: Sep. 19, 2024

(54) SEAMLESS AUDIO ROLLBACK

(71) Applicant: Roblox Corporation, San Mateo, CA (US)

(72) Inventor: Frederick William UMMINGER, III, Oakland, CA (US)

(73) Assignee: Roblox Corporation, San Mateo, CA (US)

(21) Appl. No.: 18/184,525

(22) Filed: Mar. 15, 2023

(51) Int. Cl. G10H 7/00; A63F 13/54

(52) U.S. Cl. CPC G10H 7/008; A63F 13/54; A63F 2300/6063; G10H 2210/026; G10H 2210/115; G10H 2250/005

(57) ABSTRACT

A metaverse application performs an audio rollback of a local game state by receiving user input from a user during gameplay of a virtual experience. The metaverse application renders a first game state of gameplay of the virtual experience on the user device based on the user input. The metaverse application receives information about a second game state of gameplay of the virtual experience from a server. The metaverse application determines that there is a discrepancy between the first game state and the second game state. The metaverse application determines an audio gap in the first game state where a modification to game audio is to be inserted. The metaverse application generates replacement audio, wherein a duration of the replacement audio matches a duration of the audio gap. The metaverse application renders a corrected game state on the user device that includes the replacement audio.

### BACKGROUND

Multiplayer games and online virtual experiences have technical problems caused by the latency between a user's computing device and a server. For example, if there is 250 millisecond (ms) latency between the user's computing device and a server that maintains a game state of the game world, then it takes 250 ms for an action by the user to reach the server and cause an effect on the game or virtual experience. It takes at least another 250 ms for the changed state of the game world to be communicated to the user's computing device for display to the user. As a result, a half second may have elapsed before a user can see the result of their action. This is called lag and is perceived by users as an undesirable slow and sluggish experience.

One solution to the technical issue of lag is to maintain at least a part of the state of the game or virtual experience on the user's computing device. When the user performs an action, it affects the local copy of the game state that is stored on the user's computing device and the results of the action can be seen by the user almost immediately. Meanwhile, the user's inputs in the game or virtual experience are transmitted to the server, which forwards the user inputs to other computing devices associated with remote players in the game or virtual experience so that all players see the results of the user's actions.

A problem with maintaining a local state on the user's computing device is that the local state can become out of date or inconsistent with a global state of the game or virtual experience as maintained by a server. In other words, the state determined at the server may conflict with the local state. A common solution to this problem is to treat the server state as “authoritative” and to undo any changes to the local state that contradict the server state. This is referred to as a rollback.

A problem with performing rollback is that undoing the changes to the local state can result in a sudden and discontinuous change in the game or virtual experience as rendered for the user. For example, if first audio associated with the local game state is suddenly replaced with second audio to be consistent with the server game state, the sudden discontinuity of the audio may be heard by the user as popping or clicking sounds.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments relate generally to a system and method to perform an audio rollback. According to one aspect, a computer-implemented method includes receiving user input from a user during gameplay of a virtual experience. The method further includes rendering a first game state of gameplay of the virtual experience on a user device based on the user input. The method further includes receiving information about a second game state of gameplay of the virtual experience from a server. The method further includes determining that there is a discrepancy between the first game state and the second game state. The method further includes determining an audio gap in the first game state where a modification to game audio is to be inserted. The method further includes generating replacement audio, wherein a duration of the replacement audio matches a duration of the audio gap. The method further includes rendering a corrected game state on the user device that includes the replacement audio.

In some embodiments, the replacement audio is generated by determining audio of a first spectrum prior to the audio gap and audio of a second spectrum after the audio gap, where generating the replacement audio comprises performing an interpolation of the audio of the first spectrum prior to the audio gap and the audio of the second spectrum after the audio gap. In some embodiments, the replacement audio is generated by training the audio machine-learning model to generate interpolated audio that smoothly transitions between a first input audio and a second input audio and outputting, by the audio machine-learning model, the replacement audio. In some embodiments, rendering the corrected game state includes identifying a previous frame of the first game state that corresponds to a timestamp where the replacement audio begins, determining correct input from the second game state, and applying the correct input to a present frame of the first game state to predict the corrected game state, wherein the replacement audio is applied to the corrected game state and masks audio differences between the first game state and the corrected game state. In some embodiments, the method further includes providing the replacement audio to a speaker device associated with the user device for audio playback during gameplay. In some embodiments, the audio gap has a length of up to 250 milliseconds. In some embodiments, the method further includes generating the corrected game state by identifying a previous frame in the first game state that corresponds to a first timestamp where the replacement audio begins, identifying a corresponding frame in the second game state that corresponds to a second timestamp where the replacement audio ends, providing the previous frame and the corresponding frame as input to an image machine-learning model, and outputting, with the image machine-learning model, one or more interpolated frames based on the previous frame and the corresponding frame.

According to one aspect, non-transitory computer-readable medium with instructions stored thereon that, when executed by one or more computers, cause the one or more computers to perform operations, the operations comprising: receiving user input from a user during gameplay of a virtual experience, rendering a first game state of gameplay of the virtual experience based on the user input, receiving information about a second game state of gameplay of the virtual experience from a server, determining that there is a discrepancy between the first game state and the second game state, determining an audio gap in the first game state where a modification to game audio is to be inserted, generating replacement audio, wherein a duration of the replacement audio matches a duration of the audio gap, and rendering a corrected game state that includes the replacement audio.

In some embodiments, the replacement audio is generated by determining audio of a first spectrum prior to the audio gap and audio of a second spectrum after the audio gap, where generating the replacement audio comprises performing an interpolation of the audio of the first spectrum prior to the audio gap and the audio of the second spectrum after the audio gap. In some embodiments, the replacement audio is generated by training the machine-learning model to generate interpolated audio that smoothly transitions between a first input audio and a second input audio and outputting, by the audio machine-learning model, the replacement audio. In some embodiments, rendering the corrected game state includes identifying a previous frame of the first game state that corresponds to a timestamp where the replacement audio begins, determining correct input from the second game state, and applying the correct input to a present frame of the first game state to predict the corrected game state, wherein the replacement audio is applied to the corrected game state and masks audio differences between the first game state and the corrected game state. In some embodiments, the operations further include providing the replacement audio to a speaker device associated with a user device for audio playback during gameplay. In some embodiments, the operations further include generating the corrected game state by identifying a previous frame in the first game state that corresponds to a first timestamp where the replacement audio begins, identifying a corresponding frame in the second game state that corresponds to a second timestamp where the replacement audio ends, providing the previous frame and the corresponding frame as input to an image machine-learning model, and outputting, with the image machine-learning model, one or more interpolated frames based on the previous frame and the corresponding frame.

According to one aspect, a system includes a processor and a memory coupled to the processor, with instructions stored thereon that, when executed by the processor, cause the processor to perform operations comprising: receiving user input from a user during gameplay of a virtual experience, rendering a first game state of gameplay of the virtual experience based on the user input, receiving information about a second game state of gameplay of the virtual experience from a server, determining that there is a discrepancy between the first game state and the second game state, determining an audio gap in the first game state where a modification to game audio is to be inserted, generating replacement audio, wherein a duration of the replacement audio matches a duration of the audio gap, and rendering a corrected game state that includes the replacement audio.

In some embodiments, the replacement audio is generated by determining audio of a first spectrum prior to the audio gap and audio of a second spectrum after the audio gap, where generating the replacement audio comprises performing an interpolation of the audio of the first spectrum prior to the audio gap and the audio of the second spectrum after the audio gap. In some embodiments, rendering the corrected game state includes identifying a previous frame of the first game state that corresponds to a timestamp where the replacement audio begins, determining correct input from the second game state, and applying the correct input to a present frame of the first game state to predict the corrected game state, wherein the replacement audio is applied to the corrected game state and masks audio differences between the first game state and the corrected game state. In some embodiments, the operations further include providing the replacement audio to a speaker device associated with a user device for audio playback during gameplay. In some embodiments, the audio gap has a length of up to 250 milliseconds. In some embodiments, the operations further include generating the corrected game state by identifying a previous frame in the first game state that corresponds to a first timestamp where the replacement audio begins, identifying a corresponding frame in the second game state that corresponds to a second timestamp where the replacement audio ends, providing the previous frame and the corresponding frame as input to an image machine-learning model, and outputting, with the image machine-learning model, one or more interpolated frames based on the previous frame and the corresponding frame.

In sound mixing for film, music, and games, it is often necessary to suddenly transition from one sound to another without an objectionable pop. The solution is to use a crossfade between a first sound and a second sound. For a short moment in time, both sounds play at once, with a volume of the first sound falling to zero while the volume of the second sound increases. However, this requires at least twice the central processing unit and memory resources than are used for a single sound for that period of time. In addition, when this technology is applied to a game, there may be many sounds playing when the game state needs to suddenly change. Keeping track of the multitude of sounds for both the original and the new game state, and their crossfades, is a complex and difficult task.

The application advantageously describes a metaverse application that performs a rollback of a local game state. The metaverse application determines an audio gap in the local game state where a modification to game audio is to be inserted. The metaverse application generates replacement audio that is an interpolation of audio from the local game state and audio from an authoritative game state. This advantageously avoids audio artifacts that are perceived as pops or clicks that are unpleasant for users. Furthermore, because the replacement audio plays one sound at a time, the replacement audio is more computationally efficient than using crossfade, which plays two sounds at the same time.

### BRIEF DESCRIPTION OF THE DRAWINGS

FIG. 1 is a block diagram of an example network environment to perform a rollback of a game state, according to some embodiments described herein.

FIG. 2 is a block diagram of an example computing device to perform a rollback of a game state, according to some embodiments described herein.

FIGS. 3A-3C include examples of a first frame, a second frame, and an interpolated frame, according to some embodiments described herein.

FIG. 4 is an example flow diagram of a method to perform a rollback of a game state, according to some embodiments described herein.

FIG. 5 is another example flow diagram of a method to perform a rollback of a game state, according to some embodiments described herein.

### DETAILED DESCRIPTION

### Example Network Environment 100

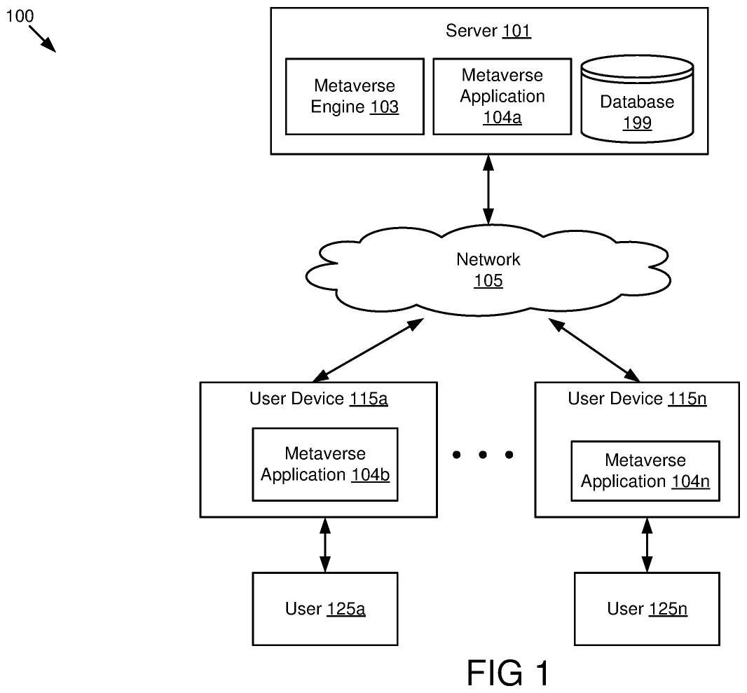

FIG. 1 illustrates a block diagram of an example environment 100 to perform a rollback of a game state. In some embodiments, the environment 100 includes a server 101, user devices 115a . . . n, and a network 105. Users 125a . . . n may be associated with the respective user devices 115a . . . n. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number. In some embodiments, the environment 100 may include other servers or devices not shown in FIG. 1. For example, the server 101 may include multiple servers 101.

The server 101 includes one or more servers that each include a processor, a memory, and network communication hardware. In some embodiments, the server 101 is a hardware server. The server 101 is communicatively coupled to the network 105. In some embodiments, the server 101 sends and receives data to and from the user devices 115. The server 101 may include a metaverse engine 103, a metaverse application 104a, and a database 199.

In some embodiments, the metaverse engine 103 includes code and routines operable to generate a metaverse. In some embodiments, the metaverse application 104a includes codes and routines operable to receive communications between two or more users 125 in a virtual metaverse, for example, at a same location in the metaverse, within a same virtual experience, or between friends within the metaverse application 104a. The users 125 interact within the metaverse across different demographics (e.g., different ages, regions, languages, etc.).

In some embodiments, the metaverse application 104a receives user input from a user device 115a that affects a remote player associated with user device 115n. For example, the virtual experience may include a multiplayer game where user input associated with the user device 115a moves a first character in the virtual experience. The metaverse application 104a transmits the user input to a user device 115n. The metaverse application 104a receives additional user input from the user device 115n that is a reaction to the user input from the user device 115a. The metaverse application 104a transmits the additional user input to the user device 115a. The metaverse engine 103 and the metaverse application 104a treat the information transmitted by the metaverse engine 103 as the authoritative version of a game state.

In some embodiments, the metaverse engine 103 and/or the metaverse application 104a are implemented using hardware including a central processing unit (CPU), a field-programmable gate array (FPGA), an application-specific integrated circuit (ASIC), any other type of processor, or a combination thereof. In some embodiments, the metaverse engine 103 is implemented using a combination of hardware and software.

The database 199 may be a non-transitory computer readable memory (e.g., random access memory), a cache, a drive (e.g., a hard drive), a flash drive, a database system, or another type of component or device capable of storing data. The database 199 may also include multiple storage components (e.g., multiple drives or multiple databases) that may also span multiple computing devices (e.g., multiple server computers). The database 199 may store data associated with the game or virtual experience hosted by the metaverse engine 103, such as a current game state, user profiles, etc.

The user device 115 may be a computing device that includes a memory, a hardware processor, and a camera. For example, the user device 115 may include a mobile device, a tablet computer, a mobile telephone, a wearable device, a head-mounted display, a mobile email device, a portable game player, a portable music player, a reader device, or another electronic device capable of accessing a network 105 and capturing images with a camera.

User device 115a includes metaverse application 104b and user device 115n includes metaverse application 104n. In some embodiments, the user 125a provides user input to the metaverse application 104b on the user device 115a via an available input device (e.g., gestures detected by a camera or sensor, touch detected by a touchscreen or sensor, keyboard, mouse, or controller input, etc.) and the user input is transmitted to metaverse engine 103. The metaverse engine 103 transmits the user input to the metaverse application 104n on the user device 115n for the user 125n to access.

The metaverse application 104b rendering a first game state of gameplay of a virtual experience on the user device 115a based on the user input. For example, the metaverse application 104b may generate graphical data to render the first game state of gameplay or only generate audio to render the first game state of gameplay. The metaverse application 104b makes a prediction about the future of the virtual experience based on the user input. For example, where the virtual experience includes a fight between two players, if the user input includes a first character punching a second character, the metaverse application 104b may predict that a second character will avoid the punch.

The metaverse application 104b receives information about a second game state from the metaverse engine 103 at the server 101. For example, the future state calculated by the metaverse application 104b that the second character that the second character avoided the punch may be wrong and instead the second character blocked the punch based on additional user input from another user. As a result, there is a discrepancy between the first game state and the second game state.

The metaverse application 104b determines that there is a discrepancy between the first game state and the second game state. The metaverse application 104b determines an audio gap in the first game state where a modification to audio is to be inserted. For example, a first noise associated with avoiding the punch may be replaced with a second noise caused by blocking the punch. Switching the noise can cause an audio artifact that is jarring to a user 125a. Instead of replacing the noise, the metaverse application 104b generates replacement audio where a duration of the replacement audio matches a duration of the audio gap. For example, the reconstructed audio may include noise that is an interpolation of the first noise and the second noise.

In some embodiments, the metaverse application 104b renders a corrected game state on the user device that includes the replacement audio. In some embodiments, the metaverse application 104a may additionally generate an interpolated frame that includes aspects of a previous frame and a corresponding frame from the corrected game state. While the foregoing example refers to two states, it is possible in some embodiments, that there are multiple different game states at individual user devices 115, and a single corrected game state (e.g., determined by the server 101, or by individual user devices 115 upon receipt of user inputs from other user devices 115). There may be the same or different discrepancies between the game state at each user device 115 and other user devices 115 and/or the server 101.

Although FIG. 1 is described with the metaverse application 104b on a user device 115a performing the above steps, some or all of these steps can also be performed by the metaverse application 104a on the server 101. For example, the metaverse application 104a may perform all the steps except the rendering step, which is performed by the metaverse application 104b on the user device 115a.

In the illustrated embodiment, the entities of the environment 100 are communicatively coupled via a network 105. The network 105 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. Although FIG. 1 illustrates one network 105 coupled to the server 101 and the user devices 115, in practice one or more networks 105 may be coupled to these entities.

### Example Computing Device 200

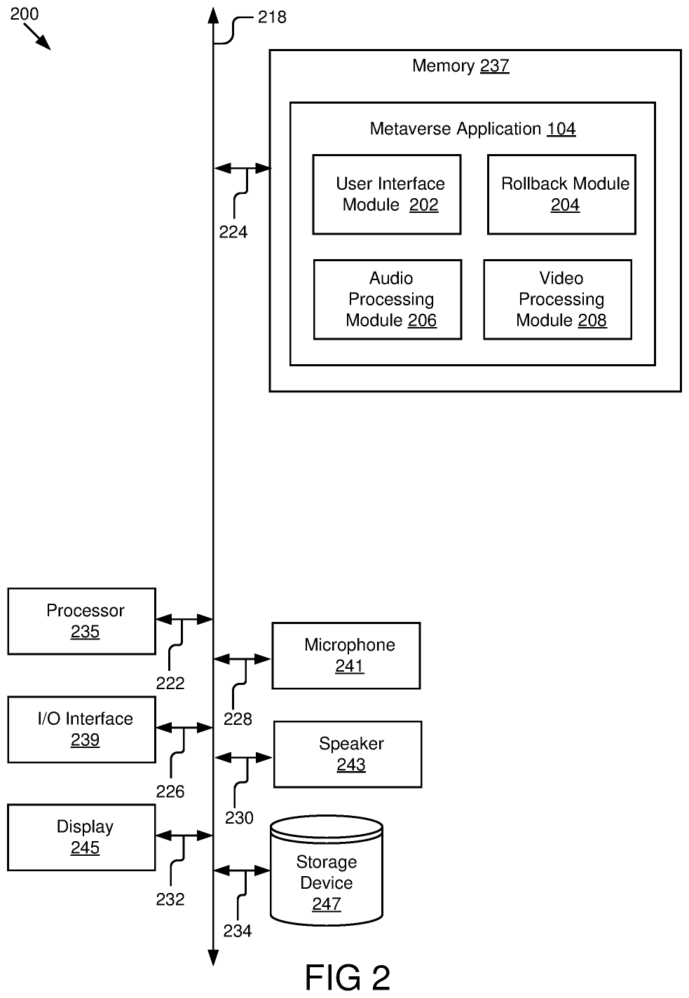

FIG. 2 is a block diagram of an example computing device 200 that may be used to implement one or more features described herein. Computing device 200 can be any suitable computer system, server, or other electronic or hardware device. In some embodiments, the computing device 200 is the user device 115.

In some embodiments, computing device 200 includes a processor 235, a memory 237, an Input/Output (I/O) interface 239, a microphone 241, a speaker 243, a display 245, and a storage device 247. In some embodiments, the computing device 200 includes additional components not illustrated in FIG. 2.

The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, and the storage device 247 may be coupled to the bus 218 via signal line 234.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200, such as a keyboard, mouse, etc.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the metaverse application 104, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 247), and input/output devices can communicate via I/O interface 239. In another example, the I/O interface 239 can receive data from the server 101 and deliver the data to the metaverse application 104 and components of the metaverse application 104, such as the rollback module 204. In some embodiments, the I/O interface 239 can connect to interface devices such as input devices (keyboard, pointing device, touchscreen, microphone 241, sensors, etc.) and/or output devices (display devices, speaker 243, monitors, etc.).

Some examples of interfaced devices that can connect to I/O interface 239 can include a display 245 that can be used to display content, e.g., images, video, and/or a user interface of the metaverse as described herein, and to receive touch (or gesture) input from a user. Display 245 can include any suitable display device such as a liquid crystal display (LCD), light emitting diode (LED), or plasma display screen, cathode ray tube (CRT), television, monitor, touchscreen, three-dimensional display screen, or other visual display device.

The microphone 241 includes hardware, e.g., one or more microphones that detect audio spoken by a person. The microphone 241 may transmit the audio to the metaverse application 104 via the I/O interface 239.

The speaker 243 includes hardware for generating audio for playback. For example, the speaker 243 receives the replacement audio as waveforms for audio playback during gameplay from the metaverse application 104.

The storage device 247 stores data related to the metaverse application 104. For example, the storage device 247 may store a local game state, a corrected game state, training data sets for a trained machine-learning model, a user profile associated with a user 125, etc.

### Example Metaverse Application 104

FIG. 2 illustrates a computing device 200 that executes an example metaverse application 104 that includes a user interface module 202, a rollback module 204, an audio processing module 206, and a video processing module 208.

The user interface module 202 generates a user interface. In some embodiments, the user interface module 202 includes a set of instructions executable by the processor 235 to generate the user interface. In some embodiments, the user interface module 202 is stored in the memory 237 of the computing device 200 and can be accessible and executable by the processor 235.

The user interface module 202 generates a user interface for users associated with user devices to participate in the metaverse. In some embodiments, before a user participates in the metaverse, the user interface module 202 generates a user interface that includes information about how the user's information may be collected, stored, and/or analyzed. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

The user interface module 202 receives user input from a user during gameplay of a virtual experience. In some embodiments, the user interface module 202 receives a local game state of gameplay (also referred to as a first game state of gameplay) of the virtual experience from the rollback module 204 and generates graphical data to render the local game state of gameplay of the virtual experience on a display 245 of the computing device 200. For example, the virtual experience may include a first-person shooter virtual experience, an adventure virtual experience, a building virtual experience, a sports virtual experience, etc.

In some embodiments, the rollback module 204 determines that there is a discrepancy between the first game state and a second game state provided by the server. Based on the determination that there is a discrepancy, the rollback module 204 may invoke the audio processing module 206 and/or the video processing module 208. The audio processing module 206 generates replacement audio. The video processing module 208 may generate one or more interpolated frames. The user interface module 202 renders a corrected game state that includes the replacement audio and/or the interpolated frames.

The rollback module 204 predicts a local game state. In some embodiments, the rollback module 204 includes a set of instructions executable by the processor 235 to predict the local game state. In some embodiments, the rollback module 204 is stored in the memory 237 of the computing device 200 and can be accessible and executable by the processor 235.

In some embodiments, the rollback module 204 receives the user input from the user interface module 202 and calculates a local game state based on the user input and predicting a remote player's next inputs. The rollback module 204 may predict the reactions, movements, positions, etc. of different users in the virtual experience based on the user input. For example, in a virtual experience that includes two cars driving down a road, the user input may include driving towards a remote players car. The rollback module 204 may predict that the remote player drives in a way that avoids a collision, does not move the car and collides with the first user's car, drives into the first user's car to create a more dramatic collision, etc. The rollback module 204 instructs the user interface module 202 to generate graphical data to render the local game state on a display 245 of the computing device 200.

In some embodiments, the rollback module 204 determines the local game state based on implementing a delay by repeating the last few frames of video until the rollback module 204 receives a second game state of gameplay of the virtual experience from a server. However, the delay may provide a negative user experience because it can result in characters staying in one position too long and then looking jumpy when action resumes. As a result, in some embodiments, the rollback module 204 determines the local game state based on both prediction of the remote player's (for one or more remote players) next inputs and a threshold amount of delay.

The rollback module 204 receives information about a second game state of gameplay of the virtual experience from the server. The second game state of gameplay may be based on user input associated with another user device 115n. For example, the second game state of gameplay may include a different action (based on input from the second user) that occurred than the predictions made in the local game state. The second game state of gameplay of the virtual experience from the server is the authoritative version of the state of gameplay because it is based on the actual user input from the remote player.

The rollback module 204 may determine that there is a discrepancy between the local game state and the second game state. For example, the local game state may have included a prediction of next input by the remote player that is different from the actual user input from the remote player that resulted in the second game state.

In some embodiments, the rollback module 204 performs a rollback of the local game state by generating a corrected game state. The corrected game state is not the same as the second game state from the server because the second game state is already too old in time to be displayed. Instead, the rollback module 204 identifies a previous frame of the first game state that corresponds to a timestamp where the replacement audio begins (as discussed in greater detail below), determines correct input from the second game state, and applies the correct input to a present frame of the local game state to predict the corrected game state. In some embodiments, the rollback module 204 does not perform a rollback of the local game state because, for example, the discrepancy between the second game state and a corrected game state are close enough to not implement a change.

The corrected game state includes audio that is different from the audio associated with the local game state. If the sound output by the speaker 243 switches from the local game state audio to the corrected game state audio, it can result in objectionable audio artifacts being produced by the speaker 243. For example, the objectionable audio artifacts may include audible pops or clicks that are unpleasant or sudden transitions in audio.

The audio processing module 206 generates replacement audio for the corrected game state. In some embodiments, the audio processing module 206 includes a set of instructions executable by the processor 235 to generate the replacement audio. In some embodiments, the audio processing module 206 is stored in the memory 237 of the computing device 200 and can be accessible and executable by the processor 235.

In some embodiments, the audio processing module 206 receives a timestamp at which the rollback occurs from the rollback module 204. The timestamp refers to a location in the game state for inserting replacement audio. In some embodiments, the audio processing module 206 receives an alternate data track that has a Boolean value corresponding to each audio sample. The Boolean value indicates whether the audio sample is correct or needs to be replaced with replacement audio. For example, a portion of an audio track may have 10 audio samples. The alternate data track may have the 10 Boolean values (shown as 1 for true, 0 for false) of [0 0 0 1 1 1 0 1 0 0]. This indicates that the fourth, fifth, sixth, and eights samples should be replaced.

In some embodiments, the audio processing module 206 detects that the rollback module 204 implemented a rollback by detecting objectionable audio artifacts in the audio. For example, the audio processing module 206 may use an algorithm that detect audible pops and clicks, e.g., based on the audio spectrum.

In some embodiments, the audio processing module 206 determines an audio gap in the first game state where a modification to game audio is to be inserted. In some embodiments, the audio gap may have a length (duration) of up to 250 milliseconds. The audio processing module 206 generates replacement audio, where a duration of the replacement audio matches a duration of the audio gap. The audio processing module 206 may generate the replacement audio by determining a spectrum of the game audio prior to the audio gap and the game audio after the audio gap. The audio processing module 206 may generate interpolated audio that is an interpolation of the game audio prior to the audio game and the game audio after the audio gap.

In some embodiments, the audio processing module 206 uses an audio machine-learning model to output the replacement audio. In some embodiments, the audio processing module 206 uses a gap filling algorithm to reconstruct audio for the audio gap. For example, the audio machine-learning model may generate replacement audio by performing an interpolation of the audio of the first spectrum prior to the audio gap and the audio of the second spectrum after the audio gap. In some embodiments, the audio machine-learning model uses audio of a first spectrum prior to the audio gap and audio of a second spectrum after the audio gap, and generates replacement audio by performing an interpolation of the audio of the first spectrum prior to the audio gap and the audio of the second spectrum after the audio gap.

In some implementations, the audio machine-learning model may use a supervised training method. During the training, training data that includes labels that identify (a) an audio gap, (b) game audio prior to the audio gap, and (c) game audio after an audio gap may be provided. Further, the training data may also include ground truth (accurate) replacement audio that smoothly transitions between the spectrum of the game audio prior to the audio gap and game audio after the audio gap. In some embodiments, the labels include identification of the location in the audio gap where pops and clicks are detected. The audio gap, the game audio prior to the audio gap, the game audio after the audio gap, and the replacement audio may each be associated with timestamps that identify the location of each event in a gameplay timeline.

The audio processing module 206 trains the audio machine-learning model to output replacement audio that is an interpolation between a first input audio and a second input audio. In some embodiments, the training data used for the audio machine-learning model includes audio streams collected with user permission for training purposes that are unlabeled and uninterrupted game audio. The audio processing module 206 may train the audio machine-learning model to randomly choose a region in the audio streams to turn into game audio. In some embodiments, the audio processing module 206 trains the audio machine-learning model using audio streams that are labelled with Boolean values that are false where there is no gap and true where there is a gap. In some embodiments, the audio processing module 206 trains the audio machine-learning model using audio streams with a timestamp for a beginning of the gap and a timestamp for an end of the gap. The training data may include original audio files that are modified to have silence or noise where the gap is located and ground truth data that includes the original audio file.

In some embodiments, the audio machine-learning model is a deep neural network. Example types of deep neural networks that can be used to implement the audio machine-learning model include convolutional neural networks, deep belief networks, stacked autoencoders, generative adversarial networks, variational autoencoders, flow models, recurrent neural networks, and attention bases models. A deep neural network uses multiple layers to progressively extract higher-level features from the raw input where the input to the layers are different types of features extracted from other modules and the outputs are replacement audio for the audio gap.

The trained audio machine-learning model may include layers that identify increasingly more detailed features and patterns within the audio gap where the output of one layer serves as input to a subsequently more detailed layer until a final output replacement audio for the audio gap. Different layers in the deep neural network may include token embeddings, segment embeddings, and/or positional embeddings.

Once the audio machine-learning model is trained with the training data, the audio machine-learning model may receive the audio gap and a spectrum of game audio prior to the audio gap and game audio after the audio gap as input to the trained machine-learning model. The trained audio machine-learning model may output the replacement audio that smoothly transitions between the spectrum of the game audio prior to the audio gap and after the audio gap.

The audio processing module 206 may apply the replacement audio to the corrected game state to mask audio differences between the first game state and the corrected game state. In some embodiments, the replacement audio is provided to a speaker device associated with the user device, such as the speaker 243 illustrated in FIG. 2, for audio playback during gameplay. This enables a single point in an audio mix chain where rollbacks are removed that might occur anywhere in an audio signal flow. The cost of processing the audio stream is constant and is independent of the number of rollbacks. No crossfades are needed where two sounds are played at once as one audio stream morphs into another audio stream and, as a result, this process of using replacement audio is more computationally efficient.

The video processing module 208 generates one or more interpolated replacement frames for a corrected game state. In some embodiments, the video processing module 208 includes a set of instructions executable by the processor 235 to generate the interpolated frames. In some embodiments, the video processing module 208 is stored in the memory 237 of the computing device 200 and can be accessible and executable by the processor 235.

The video processing module 208 generates one or more interpolated frames that correspond to a time when the replacement audio occurred. The interpolated frames are a combination of aspects of image frames prior to the audio gap and image frames after the image gap. In some embodiments, the interpolated frames bridge the gap between the image frames prior to the audio gap and the image frames after the image gap by breaking up one or more objects into sections such that when the one or more interpolated image frames are viewed along with subsequent image frames, the gameplay includes a smooth transition between the first game state and the corrected game state. For example, a single object that is in one location in a first frame and a second location in a second frame may be divided into being partially in the first location and partially in the second location.

In some embodiments, the video processing module 208 uses an image machine-learning model to output the one or more interpolated frames. The image machine-learning model may use a supervised training method by providing training data to the image machine-learning model that includes image frames prior to the audio gap, image frames after the audio gap, and interpolated frames that are a combination of the image frames prior to the audio gap and image frames after the audio gap. In some embodiments, the image machine-learning model uses training data that includes ground truth data in the form of pairs of images where each pair includes an image frame before an audio gap and an image frame after the audio gap along with an interpolated frame.

The training data may be obtained from any source, such as a data repository marked for training data, training data gathered from virtual experiences with the permission of users, etc. In some embodiments, the image machine-learning model is stored on a third-party server that provides interpolated frames in response to queries with image frames prior to an audio gap and image frames after the audio gap. In some embodiments, the image machine-learning model translates text to images to create a visual interpolation between the two different game states.

In some embodiments, the image machine-learning model may include a deep neural network. A deep neural network uses multiple layers to progressively extract higher-level features from the raw input where the input to the layers are different types of features extracted from other modules and the outputs are interpolated image frames. In some embodiments, the deep neural network is a convolutional neural network (CNN) with network layers where each network layer extracts image features at different levels of abstractions.

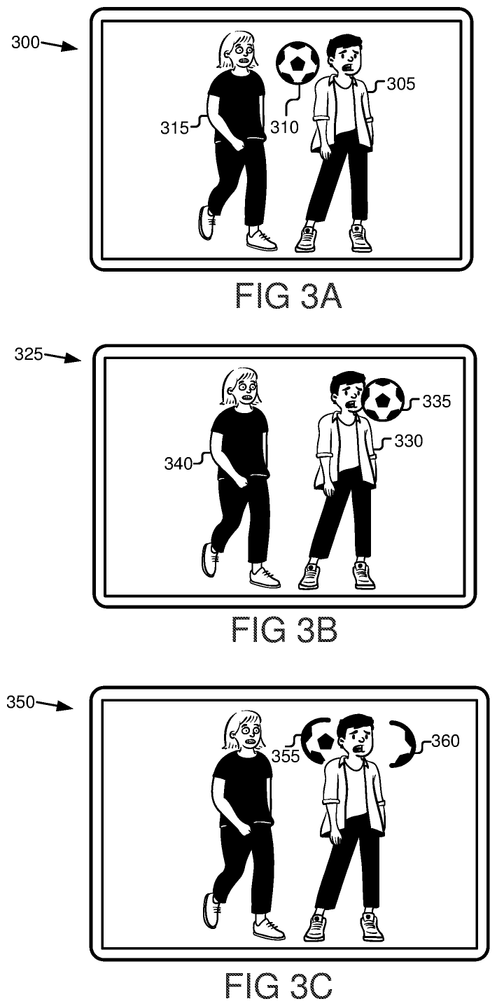

FIG. 3A illustrates a first image frame 300 that is an image frame prior to the audio gap. The first image frame 300 corresponds to an image from the first game state of gameplay of the virtual experience. In this example, the rollback module 204 predicts that a remote player 305 ducks to avoid a soccer ball 310 and, as a result, the soccer ball 310 approaches a local user 315 associated with a user device.

FIG. 3B illustrates a second image frame 325 that is an image frame after the audio gap. The second image frame 325 corresponds to an image from the second game state of gameplay of the virtual experience. In this example, the rollback module 204 receives information about the second game state from a server where the remote player 330 made contact with the soccer ball 335 because the remote player 330 did not duck. The local user 340 is not at risk of being hit by the soccer ball.

Based on the discrepancy between the first game state and the second game state, the video processing module 208 outputs the example in FIG. 3C, which illustrates an interpolated image frame 350 that is an interpolation of the image frame before the audio gap and the image frame after the audio gap. In this example, the video processing module 208 outputs the interpolated image frame 350 with the soccer ball divided into a first segment 355 and a second segment 360. The next image frame is a prediction of a current game state based on the second state of gameplay provided by the server. The interpolated image frame 350 provides an intermediate between the wrongly predicted first game state (the remote player successfully ducking the soccer ball) and the current game state (the remote player being hit by the soccer ball), which makes the gameplay look smoother and not as disjointed as an image frame that simply replaced the first game state with the second game state.

In some embodiments, the video processing module 208 identifies a previous frame in the first game state that corresponds to a first timestamp where the replacement audio begins and a corresponding frame in the second game state that corresponds to a second timestamp where the replacement audio ends. Once the image machine-learning model is trained, the image machine-learning model receives the previous frame and the corresponding frame as input and outputs one or more interpolated frames that is an interpolation of the previous frame and the corresponding frame.

### Example Methods

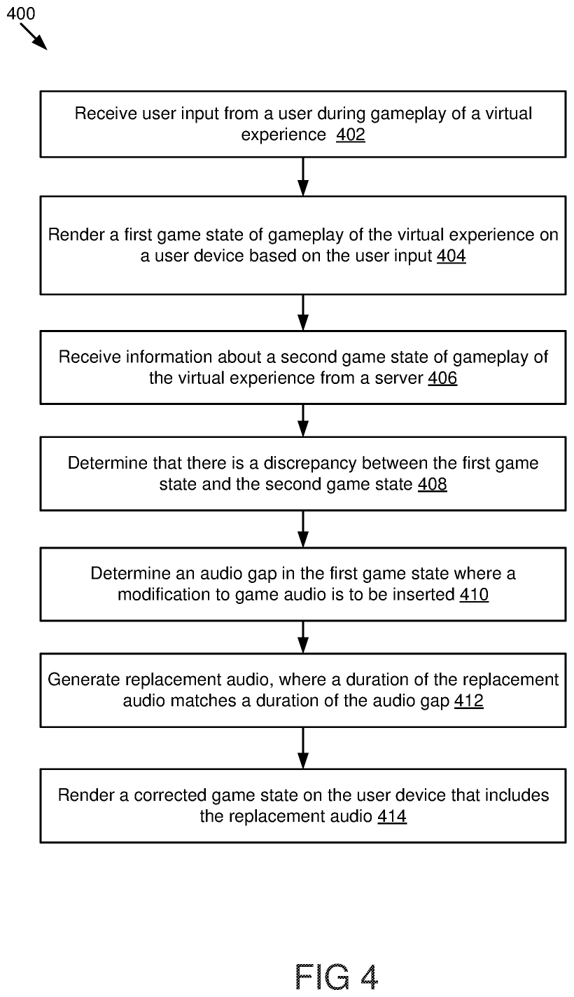

FIG. 4 is an example flow diagram of a method 400 to perform a rollback of a game state. In some embodiments, the method 400 is performed by the metaverse application 104 stored on the user device 115 as illustrated in FIG. 1 and/or the metaverse application 104 stored on the computing device 200 of FIG. 2.

The method 400 may begin with block 402. At block 402 user input is received from a user during gameplay of a virtual experience. Block 402 may be followed by block 404.

At block 404, a first game state of gameplay of the virtual experience on a user device is rendered based on the user input. For example, graphical data may be rendered or only audio may be rendered. Block 404 is followed by block 406.

At block 406, information is received from a server about a second game state of gameplay of the virtual experience. Block 406 may be followed by block 408.

At block 408, a discrepancy is determined between the first game state and the second game state. Block 408 may be followed by block 410.

At block 410, an audio gap is determined in the first game state where a modification to game audio is to be inserted. Block 410 may be followed by block 412.

At block 412, replacement audio is generated, where a duration of the replacement audio matches a duration of the audio gap. Block 412 may be followed by block 414.

At block 414, a corrected game state is rendered on the user device that includes the replacement audio.

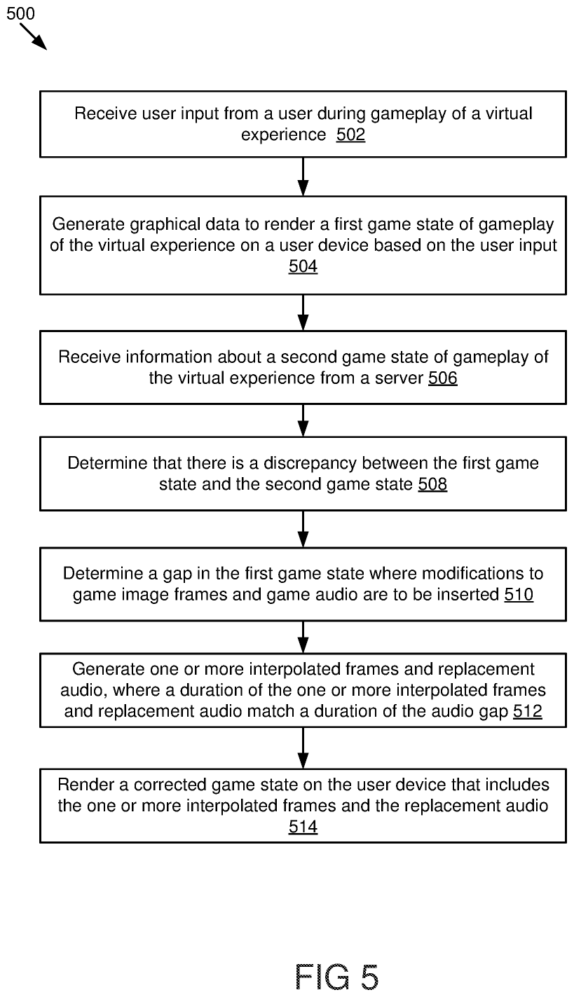

FIG. 5 is another example flow diagram of a method 500 to perform a rollback of a game state. In some embodiments, the method 500 is performed by the metaverse application 104 stored on the user device 115 as illustrated in FIG. 1 and/or the metaverse application 104 stored on the computing device 200 of FIG. 2.

The method 500 may begin with block 502. At block 502 user input is received from a user during gameplay of a virtual experience. Block 502 may be followed by block 504.

At block 504, graphical data is generated to render a first game state of gameplay of the virtual experience on a user device based on the user input. Block 504 is followed by block 506.

At block 506, information is received from a server about a second game state of gameplay of the virtual experience. Block 506 may be followed by block 508.

At block 508, a discrepancy is determined between the first game state and the second game state. Block 508 may be followed by block 510.

At block 510, a gap is determined in the first game state where modifications to game image frames and game audio are to be inserted. Block 510 may be followed by block 512.

At block 512, one or more interpolated frames and replacement audio are generated, where a duration of the one or more interpolated frames and replacement audio match a duration of the gap. Block 512 may be followed by block 514.

At block 514, a corrected game state is rendered on the user device that includes the one or more interpolated frames and the replacement audio.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks. ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving user input from a user during gameplay of a virtual experience;
rendering a first game state of gameplay of the virtual experience on a user device based on the user input;
receiving information about a second game state of gameplay of the virtual experience from a server;
determining that there is a discrepancy between the first game state and the second game state;
determining an audio gap in the first game state where a modification to game audio is to be inserted;
generating replacement audio, wherein a duration of the replacement audio matches a duration of the audio gap; and
rendering a corrected game state on the user device that includes the replacement audio.

2. The method of claim 1, wherein the replacement audio is generated by:
determining audio of a first spectrum prior to the audio gap and audio of a second spectrum after the audio gap; and
wherein generating the replacement audio comprises performing an interpolation of the audio of the first spectrum prior to the audio gap and the audio of the second spectrum after the audio gap.

3. The method of claim 1, wherein the replacement audio is generated by:
training the audio machine-learning model to generate interpolated audio that smoothly transitions between a first input audio and a second input audio; and
outputting, by the audio machine-learning model, the replacement audio.

4. The method of claim 1, wherein rendering the corrected game state includes:
identifying a previous frame of the first game state that corresponds to a timestamp where the replacement audio begins;
determining correct input from the second game state; and
applying the correct input to a present frame of the first game state to predict the corrected game state, wherein the replacement audio is applied to the corrected game state and masks audio differences between the first game state and the corrected game state.

5. The method of claim 1, further comprising:
providing the replacement audio to a speaker device associated with the user device for audio playback during gameplay.

6. The method of claim 1, wherein the audio gap has a length of up to 250 milliseconds.

7. The method of claim 1, further comprising generating the corrected game state by:
identifying a previous frame in the first game state that corresponds to a first timestamp where the replacement audio begins;
identifying a corresponding frame in the second game state that corresponds to a second timestamp where the replacement audio ends;
providing the previous frame and the corresponding frame as input to an image machine-learning model; and
outputting, with the image machine-learning model, one or more interpolated frames based on the previous frame and the corresponding frame.

8. A non-transitory computer-readable medium with instructions that, when executed by one or more computers, cause the one or more computers to perform operations, the operations comprising:
receiving user input from a user during gameplay of a virtual experience;
rendering a first game state of gameplay of the virtual experience based on the user input;
receiving information about a second game state of gameplay of the virtual experience from a server;
determining that there is a discrepancy between the first game state and the second game state;
determining an audio gap in the first game state where a modification to game audio is to be inserted;
generating replacement audio, wherein a duration of the replacement audio matches a duration of the audio gap; and
rendering a corrected game state that includes the replacement audio.

9. The computer-readable medium of claim 8, wherein the replacement audio is generated by:
determining audio of a first spectrum prior to the audio gap and audio of a second spectrum after the audio gap; and
wherein generating the replacement audio comprises performing an interpolation of the audio of the first spectrum prior to the audio gap and the audio of the second spectrum after the audio gap.

10. The computer-readable medium of claim 8, wherein the replacement audio is generated by:
training the audio machine-learning model to generate interpolated audio that smoothly transitions between a first input audio and a second input audio; and
outputting, by the audio machine-learning model, the replacement audio.

11. The computer-readable medium of claim 8, wherein rendering the corrected game state includes:
identifying a previous frame of the first game state that corresponds to a timestamp where the replacement audio begins;
determining correct input from the second game state; and
applying the correct input to a present frame of the first game state to predict the corrected game state, wherein the replacement audio is applied to the corrected game state and masks audio differences between the first game state and the corrected game state.

12. The computer-readable medium of claim 8, wherein the operations further include:
providing the replacement audio to a speaker device associated with a user device for audio playback during gameplay.

13. The computer-readable medium of claim 8, wherein the audio gap has a length of up to 250 milliseconds.

14. The computer-readable medium of claim 8, wherein the operations further include generating the corrected game state by:
identifying a previous frame in the first game state that corresponds to a first timestamp where the replacement audio begins;
identifying a corresponding frame in the second game state that corresponds to a second timestamp where the replacement audio ends;
providing the previous frame and the corresponding frame as input to an image machine-learning model; and
outputting, with the image machine-learning model, one or more interpolated frames based on the previous frame and the corresponding frame.

15. A system comprising:
a processor; and
a memory coupled to the processor, with instructions stored thereon that, when executed by the processor, cause the processor to perform operations comprising:
receiving user input from a user during gameplay of a virtual experience;
rendering a first game state of gameplay of the virtual experience based on the user input;
receiving information about a second game state of gameplay of the virtual experience from a server;
determining that there is a discrepancy between the first game state and the second game state;
determining an audio gap in the first game state where a modification to game audio is to be inserted;
generating replacement audio, wherein a duration of the replacement audio matches a duration of the audio gap; and
rendering a corrected game state that includes the replacement audio.

16. The system of claim 15, wherein the replacement audio is generated by:
determining audio of a first spectrum prior to the audio gap and audio of a second spectrum after the audio gap; and
wherein generating the replacement audio comprises performing an interpolation of the audio of the first spectrum prior to the audio gap and the audio of the second spectrum after the audio gap.

17. The system of claim 15, wherein the replacement audio is generated by:
training the audio machine-learning model to generate interpolated audio that smoothly transitions between a first input audio and a second input audio; and
outputting, by the audio machine-learning model, the replacement audio.

18. The system of claim 15, wherein rendering the corrected game state includes:
identifying a previous frame of the first game state that corresponds to a timestamp where the replacement audio begins;
determining correct input from the second game state; and
applying the correct input to a present frame of the first game state to predict the corrected game state, wherein the replacement audio is applied to the corrected game state and masks audio differences between the first game state and the corrected game state.

19. The system of claim 15, wherein the operations further include:
providing the replacement audio to a speaker device associated with a user device for audio playback during gameplay.

20. The system of claim 15, The computer-readable medium of claim 8, wherein the operations further include generating the corrected game state by:
identifying a previous frame in the first game state that corresponds to a first timestamp where the replacement audio begins;
identifying a corresponding frame in the second game state that corresponds to a second timestamp where the replacement audio ends;
providing the previous frame and the corresponding frame as input to an image machine-learning model; and
outputting, with the image machine-learning model, one or more interpolated frames based on the previous frame and the corresponding frame.
